(19) United States
(12) Patent Application Publication
(10) Pub. No.: US 2010/0007947 A1
(43) Pub. Date: Jan. 14, 2010

(54) METHOD FOR, IN PARTICULAR, OPTICAL EXAMINATION OF THE SURFACE OF A SAMPLE CARRIER FOR BIOLOGICAL OBJECTS

(75) Inventor: Jens Lembke, Lubeck (DE)

Correspondence Address: RANKIN, HILL & CLARK LLP, 38210 Glenn Avenue, WILLOUGHBY, OH, 44094-7808, US

(73) Assignee: EPPENDORF AG, Hamburg (DE)

(21) Appl. No.: 12/524,666

(22) PCT Filed: Jan. 21, 2008
(86) PCT No.: PCT/EP08/00406

§ 371 Date: Sep. 21, 2009

(30) Foreign Application Priority Data
Jan. 27, 2007 (DE) 10 2007 004234.7

(51) Int. Cl. G02B 21/26; G01N 21/01

(52) U.S. Cl. 359/393; 356/244

(57) ABSTRACT

Method for, in particular, optical examination of the surface of a sample carrier for biological objects, in which the sample carrier is arranged in the spatially-fixed observation area of a measuring facility, whereby the observation area covers a partial area of the surface of the sample carrier, and the sample carrier is moved with respect to the observation area, whereby, for examination, the sample carrier is displaced in the direction of an axis that extends in the plane of the sample carrier and rotated simultaneously in this plane.

### BACKGROUND OF THE INVENTION

Methods according to the generic part of the claims are used in various, usually cytological, applications. In particular, methods according to the generic part of the claims are used within the scope of a cell manipulation.

In methods of this type, the surfaces of biological sample carriers are examined, e.g. in order to determine the number and/or positions of biological objects, in particular cells, that are present thereupon. Suitable sample carriers are, e.g., culture dishes (Petri dishes). However, specimen slides or other facilities on which cells, for example, can be arranged, are suitable object carriers within the scope of the invention.

Usually, the sample carrier is arranged in the observation area of a spatially-fixed optical facility, e.g. in the focus of the lens of a microscope, whereby the observation area detects only a part of the surface of the object carrier. The sample carrier is then moved by means of a mechanical stage, for example, such that the measuring facility can detect all objects that are present in a defined area of the sample carrier. The positions of the detected cells can be saved and used in a subsequent cell manipulation, for example, in order to automatically move certain cells into the focus of the microscope.

In methods according to the generic part of the claims, the sample carriers are scanned line by line, which is not optimal, especially in the case of the circular Petri dishes that are commonly used as sample carriers in cell manipulation.

It is the object of the invention to create a method that facilitates the examination of surfaces of, in particular, round sample carriers in a particularly easy fashion.

### BRIEF SUMMARY OF THE INVENTION

The object is met by a method that comprises the characteristic features of the first independent claim.

Like in methods according to the generic part of the claims, the method according to the invention has the sample carrier initially arranged in the observation area of a spatially-fixed measuring facility. This is, in particular, an optical measuring facility, whereby the term “optical” is meant to be broad in meaning. The term shall also include measuring facilities that operate by means of laser radiation. Also conceivable is the use of non-optical facilities that operate by means of ultrasound, for example.

The measuring facility preferably is a microscope, a stereoscopic microscope or a camera.

The invention provides for the sample carrier to be displaced in the direction of an axis that extends in the plane of the sample carrier, and to be rotated simultaneously in this plane, whereby its surface is examined by the spatially-fixed measuring facility. Suitable devices that are capable of performing this type of sample carrier motion are specified below.

A simultaneous rotation and displacement of the sample carrier with respect to the measuring facility and/or its observation area is a particularly advantageous and space-saving option of examining the surface of an, in particular, circular sample carrier with minimal design effort.

Advantageous further developments of the invention are specified in the dependent claims.

It is advantageous for the displacement of the sample carrier to proceed along an axis that extends through its center and the observation area of the measuring facility. If, for example, a Petri dish is displaced along a preferred axis of this type, then displacement by a length that corresponds to the radius of the Petri dish in the presence of simultaneous rotation is sufficient to detect all surface areas by the measuring facility.

As described above, the measuring facilities that are utilized in the scope of the method according to the invention are capable of detecting biological objects, in particular cells, that are present on the surface of the sample carrier. This can be done, for example, in order to count these objects.

However, it is particularly preferred to provide that the method according to the invention is performed in order to determine the position of objects that are present on the sample carrier. The positions, thus determined, are then saved and can be used to find the cells at a later point in time, for example within the scope of a cell manipulation. The positions can be defined particularly easily in the form of path length/angle coordinates, i.e. one coordinate corresponds to a position on the axis along which the sample carrier is displaced. The other coordinate is the rotation angle.

It is self-evident that the invention is not limited to sample carriers with circular surfaces. Other surfaces can be measured just as well, but one needs to be aware that the measuring facility will, in part, detect areas that are not part of the surface of the sample carrier.

The invention relates not only to a method for the examination of the surface of a sample carrier, but also concerns devices that can be used in this context.

A device according to the invention includes a receptacle for a sample carrier and a drive facility that is allocated to the receptacle and can displace the receptacle by a defined path length along an axis that extends in the plane of the receptacle and simultaneously rotate it in the plane of the receptacle.

The device according to the invention can be used as a separate stand-alone device in conjunction with a stereoscopic microscope, for example.

However, it is advantageous to provide further facilities that allow for defined arrangement and/or attachment on or to the measuring facility.

In this context, it is advantageous to provide the device according to the invention to include standardized connection facilities that allow for arrangement on microscope tables. Microscope tables usually have standardized dimension and standardized bore holes provided that allow, for example, microscope stages etc. to be adjoined. Devices according to the invention having corresponding standardized dimensions are particularly easy to use in conjunction with different microscopes.

Another advantageous further development of the invention provides at least one, usually two, manipulators to be arranged on the device. The device according to the invention, thus, is a unit that includes all facilities required for micro-manipulation with the exception of the optical components. If it is appropriately standardized, it is particularly easy to switch from one microscope to another microscope, for example. As another advantage, vibration effects are minimized in this further development.

It is self-evident that the further development of the device described above does not necessarily have to be attached to an optical measuring facility. It is also conceivable to set it up in the area of a stereoscopic microscope or other measuring facility without there necessarily having to exist a connection between microscope and device.

### BRIEF DESCRIPTION OF THE DRAWINGS

The invention shall be illustrated in more detail in the following based on two figures.

FIG. 1 shows a schematic view of the application of the method according to the invention in the examination of a Petri dish.

FIG. 2 shows an embodiment of a device that can be utilized in the method according to the invention.

### DETAILED DESCRIPTION OF THE INVENTION

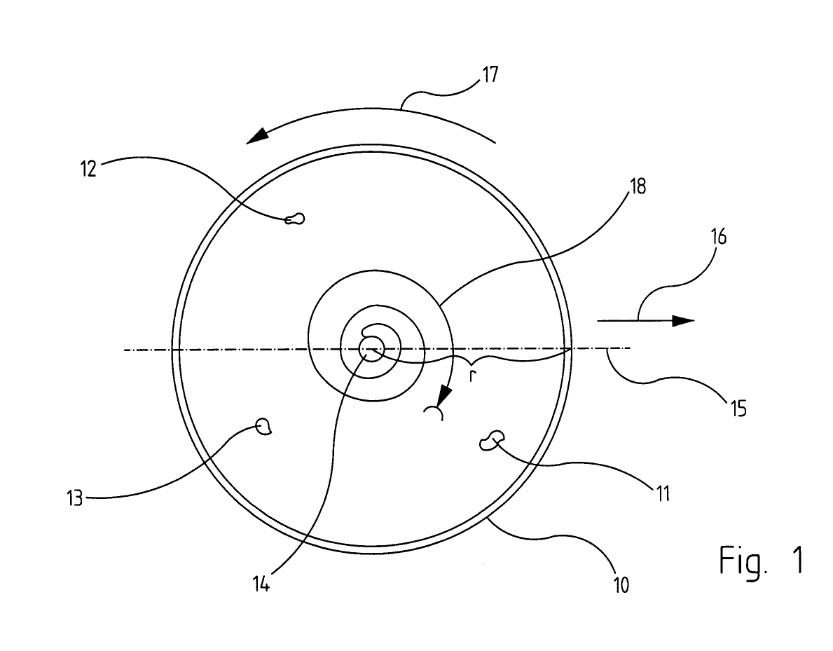

FIG. 1 shows a Petri dish 10, in which biological objects 11, 12, and 13 are present. Usually, these are cells that are to be manipulated. The Petri dish 10 is arranged in the observation area 14 of a measuring facility that is not shown herein. The observation area 14 can, in particular, be the focal point of a microscope that is directed at the center of the Petri dish 10 at the start of the measurement as shown. It is self-evident that the observation area can just as well be directed at any other point of the Petri dish. In this case, there may only be a need to effect the displacement in forward and back direction, in order to detect all parts of the surface.

In the scope of the present invention, the Petri dish 10 is displaced along an axis 15, for example in the direction of arrow 16, and simultaneously rotated in the direction of arrow 17. In this context, the line 18, which extends from the observation area 14 outwards in a spiral shape, indicates how the Petri dish is moved with respect to the observation area 14.

It is evident that displacement restricted to just the path length of radius r is sufficient for all areas of the Petri dish 10 to be moved past the observation area, e.g. the focal point of a microscope 14.

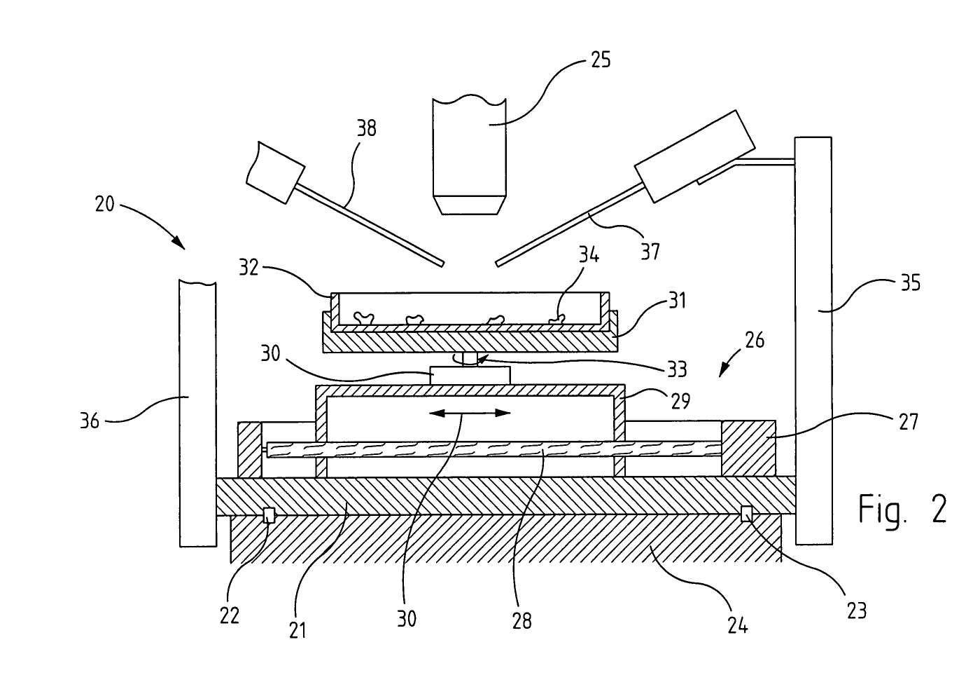

FIG. 2 shows an embodiment of a device 20 according to the invention. The device 20 comprises a base plate 21 that is attached to a table 24 of a microscope. A lens 25 is the only other component of the microscope that is shown here. All other components have been omitted for reasons of clarity.

A drive facility 26 comprising a spindle drive having a torque motor 27 and a spindle 28 is shown on the base plate 21. The drive facility further comprises a carrier 29 that can be re-adjusted in the direction of an arrow 30 by means of the spindle 28, as well as a torque drive 30 that is provided on the carrier 29 and can be used to rotate a receptacle 31 for a Petri dish 32 in the direction of an arrow 33.

Accordingly, the drive 26 can be used to effect the motion of the Petri dish 32 past the lens 25 as shown in FIG. 1. In the course of this motion, the lens 25 detects biological objects 33, in particular cells 34, that are present in the Petri dish 32.

Moreover, FIG. 2 shows, in a schematic fashion, manipulator facilities 35, 36 that can be used to move cannulas 37 and 38 for cell manipulation. The manipulation facilities 35, 36 are connected to the base plate 21. In the embodiment shown, the device 20, thus, is an assembly that can be conveniently switched from one microscope to another and includes all components required for cell manipulation with the exception of the optical system.

It is self-evident that modular assemblies, in which multiple devices are operated in parallel, are also conceivable.

1. Method for optical examination of the surface of a sample carrier (10) for biological objects (11, 12, 13), in which the sample carrier (10) is arranged in the spatially-fixed observation area (14) of a measuring facility, whereby the observation area (14) covers a partial area of the surface of the sample carrier (10), and the sample carrier (10) is moved with respect to the observation area (14), comprising the steps of:
for examination, displacing the sample carrier (10) in the direction of an axis (15) that extends in the plane of the sample carrier (10), and
rotating the sample carrier simultaneously in this plane.

2. Method according to claim 1, wherein all points of the surface of the sample carrier (10) are detected at least once by the measuring facility during the displacement and rotation of the sample carrier (10).

3. Method according to claim 1, wherein the displacement of the sample carrier proceeds in the direction of an axis that extends through the center of the sample carrier (10) and the observation area (14) of the measuring facility.

4. Method according to claim 3, wherein the displacement proceeds by half of the longest extension of the surface of the sample carrier.

5. Method according to claim 1, wherein the sample carrier is a Petri dish.

6. Method according to claim 1, wherein the position of biological objects that are being detected by the measuring facility during the measurement is determined.

7. Method according to claim 6, wherein the determined positions are saved in the form of path length/angle coordinates.

8. Method according to claim 1, wherein the measuring facility is a microscope.

9. Method according to claim 1, wherein the biological objects are cells that are to be manipulated.

10. Device for performing the method according to claim 1, comprising:
a receptacle (31) for a sample carrier (32), and
a drive facility (26, 30) that is allocated to the receptacle (31) and can displace the receptacle (31) by a defined path length along an axis that extends in the plane of the receptacle (31) and simultaneously rotate it in this plane.

11. Device according to claim 10, wherein at least one manipulator facility is provided on the device and can be used to subject biological objects that are present on the sample carrier to a cell biological treatment.

12. Device according to claim 11, wherein the device is designed in the form of a standardized assembly that can be arranged on a microscope.
